(19) United States
(12) Patent Application Publication
(10) Pub. No.: US 2013/0201348 A1
(43) Pub. Date: Aug. 8, 2013

(54) CAPACITIVE TOUCH PANEL

(71) Applicants: Wintek (China) Technology Ltd., Dongguan City (CN); WINTEK CORPORATION, Taichung City (TW)

(72) Inventors: Chong-Wei Li, Changhua County (TW); Shiao-Hui Liao, Taichung City (TW); Ching-Fu Hsu, Taichung City (TW); Heng-Yi Chang, Taipei City (TW); Yu-Hua Wu, Taoyuan County (TW)

(73) Assignees: WINTEK CORPORATION, Taichung City (TW); Wintek (China) Technology Ltd., Dongguan City (CN)

(21) Appl. No.: 13/751,149

(22) Filed: Jan. 28, 2013

(30) Foreign Application Priority Data
Feb. 8, 2012 (TW) 101104013

(51) Int. Cl. G06F 3/044

(52) U.S. Cl. CPC G06F 3/044
USPC 348/174

(57) ABSTRACT

A capacitive touch panel includes a substrate, a plurality of first axis electrodes, and a plurality of second axis electrodes. Each of the first axis electrodes includes at least one first sensing electrode, and the first sensing electrode has a first electrode pattern region and a second electrode pattern region. Each of the second axis electrodes includes at least one second sensing electrode, and the second sensing electrode has a third electrode pattern region and a fourth electrode pattern region. A pattern density of the first electrode pattern region is higher than a pattern density of the second electrode pattern region, and a pattern density of the third electrode pattern region is higher than a pattern density of the fourth electrode pattern region.

### BACKGROUND OF THE INVENTION

1. Field of the Invention

The present invention relates to a capacitive touch panel, and more particularly, to a capacitive touch panel having electrode pattern regions with different pattern densities within one sensing electrode.

2. Description of the Prior Art

In recent years, touch sensing technologies have developed flourishingly, and electronic products, such as mobile phones, GPS navigator systems, tablet PCs, personal digital assistances (PDA), and laptop PCs, which are integrated with the touch sensing function, are commercialized accordingly. There are many diverse technologies of touch panel, and the resistance touch technology, the capacitive touch technology and the optical touch technology are the main touch technologies in use. The capacitive touch technology has become the mainstream touch technology for the high-end and the mid-end consumer electronics, because the capacitive touch panel has advantages, such as high precision, multi-touch properties, better endurance, and higher touch resolution.

In the capacitive touch technology, sensing electrodes are used to detect the variations of electrical capacitances around a touch point, and feedback signals are transmitted via connecting lines, which interconnect all of the transparent sensing electrodes along different axis directions to locate the touch points. The size of the electrode pattern in the sensing electrode has to be controlled to keep the touch object such as human finger from being located in only one electrode pattern. Otherwise, the actual touch position may not be calculated correctly. Therefore, the amount of the channels in the processor or the integrated circuit (IC) has to be increased as the size of the touch panel increases, and the calculating procedure may become more complicated accordingly. In other words, as the sensing electrode has to be controlled according to a specific size, more hardware resources for calculation and higher production costs may be required in larger size capacitive touch panels. Therefore, related industries still work on overcoming the limitation of the electrode pattern size and realizing high touch resolution on large-sized touch panel without increasing the channel numbers of the IC.

There are many approaches to enhance the touch sensibility of the capacitive touch panels. For example, in Taiwan Patent No. 1332169, effective areas of electrode patterns in different axis sensing electrodes are different from each other by modifying hollow parts in the electrode patterns. The touch sensibility of the capacitive touch panels may be enhanced because different capacitive effects may be generated by the electrode patterns with different effective areas. However, the touch resolution still cannot be improved by this design of the electrode patterns.

### SUMMARY OF THE INVENTION

It is one of the objectives of the present invention to provide a capacitive touch panel. Touch resolution of the capacitive touch panel is enhanced by sensing electrodes having electrode pattern regions with different pattern densities.

To achieve the purposes described above, a preferred embodiment of the present invention provides a capacitive touch panel. The capacitive touch panel includes a substrate, a plurality of first axis electrodes, and a plurality of second axis electrodes. The first axis electrodes are disposed on the substrate, and the first axis electrodes extend along a first direction. Each of the first axis electrodes includes at least one first sensing electrode, and the first sensing electrode has a first electrode pattern region and a second electrode pattern region. The second axis electrodes are disposed on the substrate, and the second axis electrodes extend along a second direction. Each of the second axis electrodes includes at least one second sensing electrode, and the second sensing electrode has a third electrode pattern region and a fourth electrode pattern region. A pattern density of the first electrode pattern region is higher than a pattern density of the second electrode pattern region, and a pattern density of the third electrode pattern region is higher than a pattern density of the fourth electrode pattern region.

In the present invention, the sensing electrode, which has electrode pattern regions with different pattern densities, is employed to effectively enhance the touch resolution of the capacitive touch panel without changing the size of the sensing electrode and the channel number of the corresponding processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top-view schematic diagram illustrating a capacitive touch panel according to a first preferred embodiment of the present invention.

FIG. 2 is a cross-sectional view diagram taken along cross-sectional line A-A′ in FIG. 1.

FIG. 3 is a cross-sectional view diagram illustrating a capacitive touch panel according to a second preferred embodiment of the present invention.

FIG. 4 is a cross-sectional view diagram illustrating a capacitive touch panel according to a third preferred embodiment of the present invention.

FIG. 5 is a cross-sectional view diagram illustrating a capacitive touch panel according to a fourth preferred embodiment of the present invention.

FIG. 6 is a schematic diagram illustrating a touch sensing operation of a capacitive touch panel under a first driving mode according to a preferred embodiment of the present invention.

FIG. 7 is a schematic diagram illustrating a touch sensing operation of a capacitive touch panel under a second driving mode according to a preferred embodiment of the present invention.

FIG. 8 is a schematic diagram illustrating a comparison of charging times in different regions with different pattern densities.

FIG. 9 is a schematic diagram illustrating a comparison of discharging times in different regions with different pattern densities.

FIG. 10 is a schematic diagram illustrating a capacitive touch panel according to a fifth preferred embodiment of the present invention.

FIG. 11 is a schematic diagram illustrating a capacitive touch panel according to a sixth preferred embodiment of the present invention.

FIG. 12 is a schematic diagram illustrating a capacitive touch panel according to a seventh preferred embodiment of the present invention.

FIG. 13 is a top-view schematic diagram illustrating a capacitive touch panel according to an eighth preferred embodiment of the present invention.

FIG. 14 is a cross-sectional view diagram taken along cross-sectional line B-B′ in FIG. 13.

### DETAILED DESCRIPTION

Certain terms are used throughout the description and following claims to refer to particular components. As one skilled in the art will understand, electronic equipment manufacturers may refer to a component by different names. This document does not intend to distinguish components that differ in name but not function. In the following description and in the claims, the term “include” is used in an open-ended fashion, and thus should be interpreted to mean “include, but not limited to . . . ” In addition, to simplify the descriptions and make it more convenient to compare embodiments between each other, identical components are marked with the same reference numerals in each of the following embodiments. Please note that the figures are only for illustration and the figures may not be to scale. Additionally, the terms such as “first” and “second” in this context are only used to distinguish different components and do not constrain the order of generation.

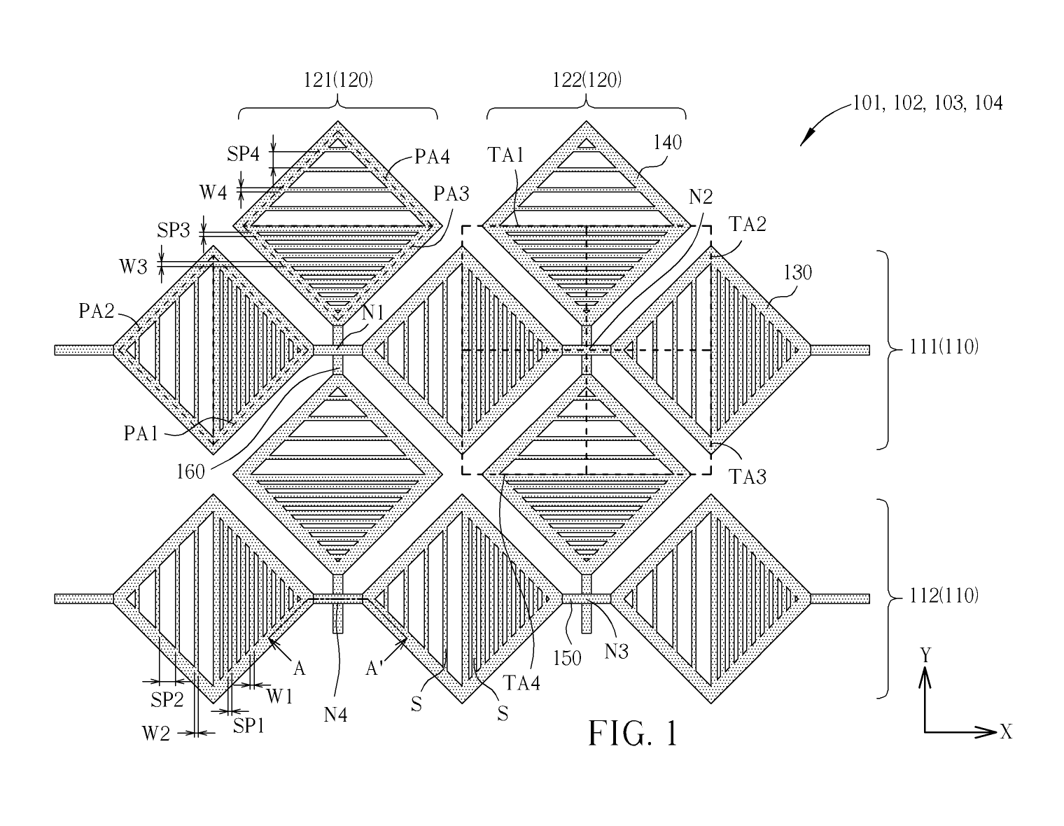

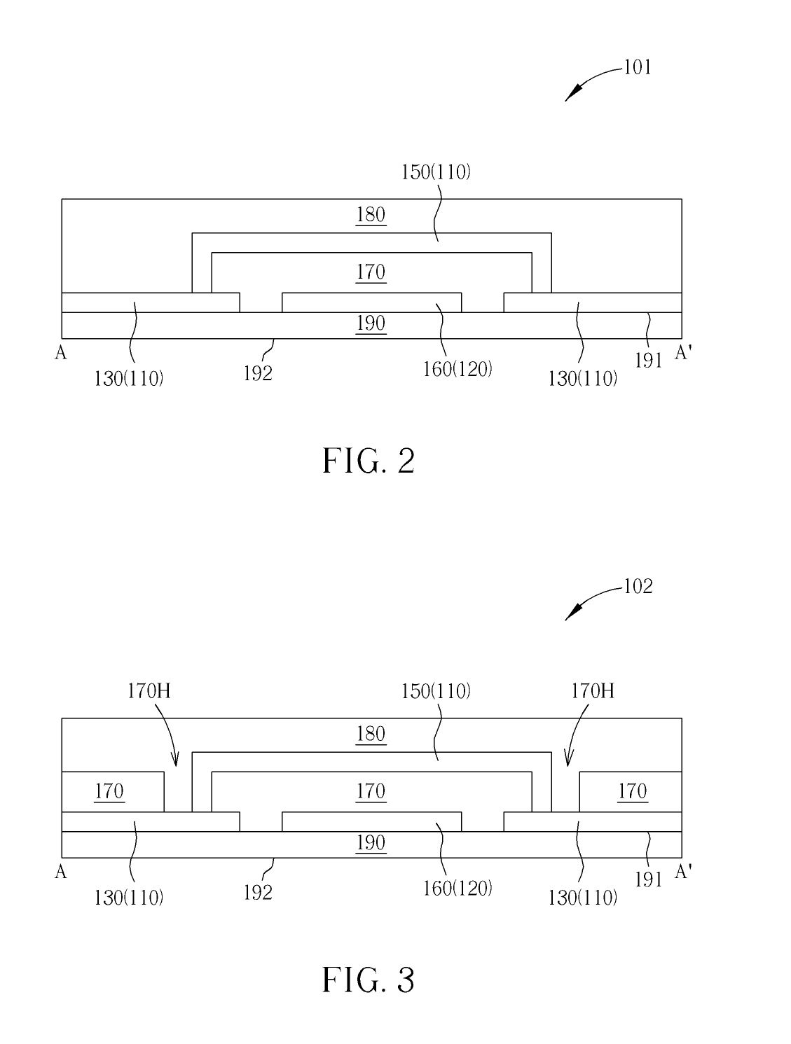

Please refer to FIG. 1 and FIG. 2. FIG. 1 and FIG. 2 are schematic diagrams illustrating a capacitive touch panel according to a first preferred embodiment of the present invention. FIG. 1 is a top-view diagram and FIG. 2 is a cross-sectional view diagram taken along cross-sectional line A-A′ in FIG. 1. Please note that the figures are only for illustration and the figures may not be to scale. The scale may be further modified according to different design considerations. As shown in FIG. 1 and FIG. 2, the first preferred embodiment of the present invention provides a capacitive touch panel 101. The capacitive touch panel 101 includes a substrate 190, a plurality of first axis electrodes 110, and a plurality of second axis electrodes 120. The substrate 190 has a first surface 191 and a second surface 192. The substrate 190 may include a rigid substrate, such as a glass substrate and a ceramic substrate, a flexible substrate, such as a plastic substrate, or other substrates made of appropriate materials. The first axis electrodes 110 are disposed on the first surface 191 of the substrate 190, and the first axis electrodes 110 extend along a first direction X. Each of the first axis electrodes 110 may include a plurality of first sensing electrodes 130 and a plurality of first connecting electrodes 150. The first sensing electrodes 130 are disposed along the first direction X, and each of the first connecting electrodes 150 is respectively disposed between two adjacent first sensing electrodes 130 to electrically connect the first sensing electrodes 130 of one first axis electrode 110. The second axis electrodes 120 are disposed on the first surface 191 of the substrate 190, and the second axis electrodes 120 extend along a second direction Y. Each of the second axis electrodes 120 may include a plurality of second sensing electrodes 140 and a plurality of second connecting electrodes 160. The second sensing electrodes 140 are disposed along the second direction Y, and each of the second connecting electrodes 160 is respectively disposed between two adjacent second sensing electrodes 140 to electrically connect the second sensing electrodes 140 of one second axis electrode 120. In this embodiment, the first direction X is substantially perpendicular to the second direction Y, but not limited thereto. It is worth noting that each of the first sensing electrodes 130 has a first electrode pattern region PA1 and a second electrode pattern region PA2, and each of the second sensing electrodes 140 has a third electrode pattern region PA3 and a fourth electrode pattern region PA4. A shape of the first electrode pattern region PA1 is symmetric to a shape of the second electrode pattern region PA 2 of the first sensing electrode 130, and a shape of the third electrode pattern region PA3 is symmetric to a shape of the fourth electrode pattern region PA4 of the second sensing electrode 140. A pattern density of the first electrode pattern region PA1 is higher than a pattern density of the second electrode pattern region PA2, and a pattern density of the third electrode pattern region PA3 is higher than a pattern density of the fourth electrode pattern region PA4. Because of the differences in the pattern densities, capacitive effects generated on the first electrode pattern region PA1, the second electrode pattern region PA2, the third electrode pattern region PA3, and the fourth electrode pattern region PA4 may be different from each other when a conductive touch object, such as a human finger or conductive stylus, touches the first electrode pattern region PA1, the second electrode pattern region PA2, the third electrode pattern region PA3, and the fourth electrode pattern region PA4. Driving methods of sensing signals and calculating methods may be modified according to the structure detailed above to increase the touch resolution of the capacitive touch panel 101. The driving method of the touch signals and the calculating method of the present invention will be detailed in other parts of this content.

As shown in FIG. 1, in the capacitive touch panel 101 of this embodiment, each of the first sensing electrodes 130 and each of the second sensing electrodes 140 may include a plurality of stripe patterns S, but not limited thereto. In other words, the differences in the pattern densities between the first electrode pattern region PA1 and the second electrode pattern region PA2 may be made by adjusting widths of the stripe patterns S and spacings between two adjacent stripe patterns S in the first electrode pattern region PA1 and the second electrode pattern region PA2. The differences in the pattern densities between the third electrode pattern region PA3 and the fourth electrode pattern region PA4 may be made by adjusting widths of the stripe patterns S and spacings between two adjacent stripe patterns S in the third electrode pattern region PA3 and the fourth electrode pattern region PA4. But the present invention is not limited to this, and other appropriate electrode patterns may also be employed in the first electrode pattern region PA1, the second electrode pattern region PA2, the third electrode pattern region PA3, and the fourth electrode pattern region PA4 to generate the differences of pattern density. In other words, a width W1 of each of the stripe patterns S in the first electrode pattern region PA1 may be different from a width W2 of each of the stripe patterns S in the second electrode pattern region PA2, or a spacing SP1 between two adjacent stripe patterns S in the first electrode pattern region PA1 may be different from a spacing SP2 between two adjacent stripe patterns S in the second electrode pattern region PA2. Additionally, a width W3 of each of the stripe patterns S in the third electrode pattern region PA3 may be different from a width W4 of each of the stripe patterns S in the fourth electrode pattern region PA4, or a spacing SP3 between two adjacent stripe patterns S in the third electrode pattern region PA3 may be different from a spacing SP4 between two adjacent stripe patterns S in the fourth electrode pattern region PA4. For example, as shown in FIG. 1, the pattern density of the first electrode pattern region PA1 may be larger than the pattern density of the second electrode pattern region PA2 because the width W1 of each of the stripe patterns S in the first electrode pattern region PA1 may be equal to the width W2 of each of the stripe patterns S in the second electrode pattern region PA2, and the spacing SP1 between two adjacent stripe patterns S in the first electrode pattern region PA1 may be smaller than the spacing SP2 between two adjacent stripe patterns S in the second electrode pattern region PA2. According to the same rule, the pattern density of the third electrode pattern region PA3 may be larger than the pattern density of the fourth electrode pattern region PA4 because the width W3 of each of the stripe patterns S in the third electrode pattern region PA3 may be equal to the width W4 of each of the stripe patterns S in the fourth electrode pattern region PA4, and the spacing SP3 between two adjacent stripe patterns S in the third electrode pattern region PA3 may be smaller than the spacing SP4 between two adjacent stripe patterns S in the fourth electrode pattern region PA3. In other words, the pattern density of each of the electrode pattern region may be modified by adjusting the width of the stripe pattern or/and the spacing between two adjacent stripe patterns in other preferred embodiments of the present invention. It is worth noting that, in this embodiment, each of the first electrode pattern regions PA1 and each of the second electrode pattern regions PA2 are alternately disposed along the first direction X, and each of the third electrode pattern regions PA3 and each of the fourth electrode pattern regions PA4 are alternately disposed along the second direction Y. A touch region TA1, a touch region TA2, a touch region TA3, and a touch region TA4 may be formed in a region wherein each first axis electrode 110 crosses each second axis electrode 120. The touch region TA1 includes a part of the first electrode pattern region PA1 and a part of the third electrode pattern region PA3, the touch region TA2 includes a part of the second electrode pattern region PA2 and a part of the third electrode pattern region PA3, the touch region TA3 includes a part of the second electrode pattern region PA2 and a part of the fourth electrode pattern region PA4, and the touch region TA4 includes a part of the first electrode pattern region PA1 and a part of the fourth electrode pattern region PA4. The capacitive effects generated on the touch region TA1, the touch region TA2, the touch region TA3, and the touch region TA4 may be different from each other when a conductive object, such as a human finger or a conductive stylus, touches the touch region TA1, the touch region TA2, the touch region TA3, and the touch region TA4 because the pattern density of the first electrode pattern region PA1 is larger than the pattern density of the second electrode pattern region PA2, and the pattern density of the third electrode pattern region PA3 is larger than the pattern density of the fourth electrode pattern region PA4. The touch resolution may be accordingly enhanced.

As shown in FIG. 2, the capacitive touch panel 101 in this embodiment may further include an insulating layer 170 and a protection layer 180 disposed on the substrate 190. The insulating layer 170 is disposed between the first connecting electrode 150 and the second connecting electrode 160. The insulating layer 170 is employed to electrically insulate the first connecting electrode 150 from the second connecting electrode 160 in the region wherein each first axis electrode 110 crosses each second axis electrode 120. The protection layer 180 may be employed to cover the first axis electrodes 110 and the second axis electrodes 120 to protect the first axis electrodes 110 and the second axis electrodes 120. Materials of the insulating layer 170 and the protection layer 180 may respectively include inorganic materials, such as silicon nitride, silicon oxide, and silicon oxynitride, organic materials, such as acrylic resins, or other appropriate materials. In this embodiment, materials of the first axis electrodes 110 and the second axis electrodes 120 may include transparent conductive materials such as indium tin oxide (ITO), indium zinc oxide (IZO), and aluminum zinc oxide (AZO), or other appropriate non-transparent conductive materials such as silver (Ag), aluminum (Al), copper (Cu), magnesium (Mg), molybdenum (Mo), a stack layer of the above-mentioned materials, or an alloy of the above-mentioned materials, but not limited thereto. It is worth noting that each of the first axis electrodes 110 and each of the second axis electrodes 120 may be respectively formed by an identical material in order to simplify the manufacturing process, but the present invention is not limited to this, and each of the first sensing electrodes 130, each of the first connecting electrodes 150, each of the second sensing electrodes 140, and each of the second connecting electrodes 160 may also be made of different materials according to different considerations. For example, each of the first sensing electrodes 130, each of the second sensing electrodes 140, and each of the second connecting electrodes 160 may be made of an identical transparent conductive material such as ITO, and the first connecting electrodes 150 may be made of a single-layer bridge, such as a metal bridge or a transparent conductive bridge (for example, an ITO bridge), or a multi-layer bridge, which may include a stack structure of metal materials and transparent conductive materials to lower the electrical resistance of the first axis electrode 110. It is worth noting that the insulating layer 170 in this embodiment may be selectively disposed only on the regions where the first axis electrodes 110 cross the second axis electrodes 120 so as to electrically insulate the first connecting electrode 150 from the second connecting electrode 160. As shown in FIG. 2, the insulating layer 170 may cover the substrate 190, the first sensing electrodes 130, and the second connecting electrode 160, and partially expose the first sensing electrodes 130. The first connecting electrode 150 may be disposed on the insulating layer 170 and electrically connected to the first sensing electrodes disposed adjacently to each other.

Please refer to FIG. 1 and FIG. 3. FIG. 1 and FIG. 3 are schematic diagrams illustrating a capacitive touch panel according to a second preferred embodiment of the present invention. FIG. 1 is a top-view diagram and FIG. 3 is a cross-sectional view diagram taken along cross-sectional line A-A′ in FIG. 1. As shown in FIG. 1 and FIG. 3, the difference between the capacitive touch panel 102 of this embodiment and the capacitive touch panel 101 of the first preferred embodiment is that, in the capacitive touch panel 102, the insulating layer 170 covers the first sensing electrodes 130, the second sensing electrodes 140, and the second connecting electrodes 160. The insulating layer 170 has a plurality of contact holes 170H partially exposing each of the first sensing electrodes 130. Each of the first connecting electrodes 150 is electrically connected to a first sensing electrode 130 through a contact hole 170H. It is worth noting that the contact holes 170H of the insulating layer 170 in this embodiment may be partially filled with the first connecting electrodes 150. In other preferred embodiment of the present invention, the contact holes 170H may also be completely filled with the first connecting electrodes 150 so as to electrically connect the first connecting electrodes 150 with the first sensing electrodes 130. Apart from the allocations of the insulating layer 170 and the contact holes 170H in this embodiment, the other components, allocations and material properties of this embodiment are similar to those of the capacitive touch panel 101 in the first preferred embodiment detailed above and will not be redundantly described.

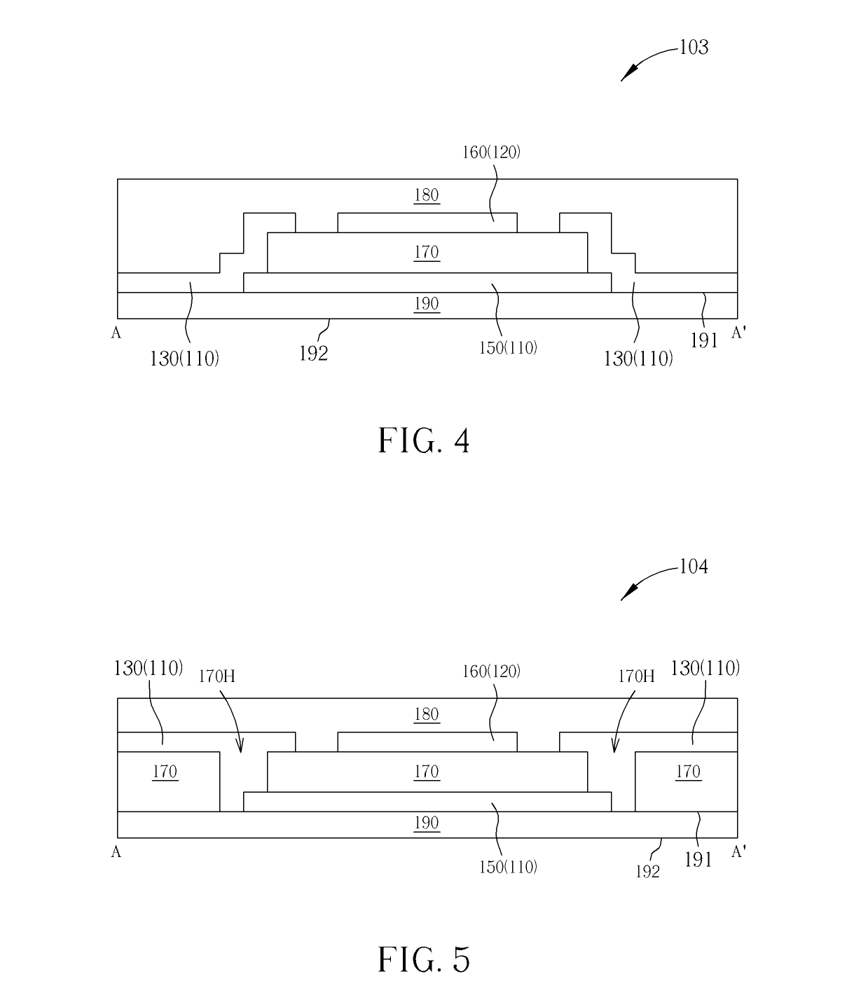

Please refer to FIG. 1 and FIG. 4. FIG. 1 and FIG. 4 are schematic diagrams illustrating a capacitive touch panel according to a third preferred embodiment of the present invention. FIG. 1 is a top-view diagram and FIG. 4 is a cross-sectional view diagram taken along cross-sectional line A-A′ in FIG. 1. As shown in FIG. 1 and FIG. 4, the difference between the capacitive touch panel 103 of this embodiment and the capacitive touch panel 101 of the first preferred embodiment is that, in the capacitive touch panel 103, the first connecting electrode 150 is disposed between the substrate 190 and the insulating layer 170. The second connecting electrodes 160 are disposed on the insulating layer 170. The insulating layer 170 covers the first connecting electrode 150 and partially exposes two edges of the first connecting electrode 150 and the substrate 190. The first sensing electrodes 130 are disposed on the substrate 190 and electrically connected to the exposed two edges of the first connecting electrode 150. In other words, in this embodiment, the first connecting electrodes 150 and the insulating layer 170 may be formed sequentially on the substrate 190, and the first connecting electrodes 150 may be partially exposed by the insulating layer 170 so as to be electrically connected to the first sensing electrode 130 formed subsequently. The components, allocations and material properties of this embodiment are similar to those of the capacitive touch panel 101 in the first preferred embodiment detailed above and will not be redundantly described.

Please refer to FIG. 1 and FIG. 5. FIG. 1 and FIG. 5 are schematic diagrams illustrating a capacitive touch panel according to a fourth preferred embodiment of the present invention. FIG. 1 is a top-view diagram and FIG. 5 is a cross-sectional view diagram taken along cross-sectional line A-A′ in FIG. 1. As shown in FIG. 1 and FIG. 5, the difference between the capacitive touch panel 104 of this embodiment and the capacitive touch panel 103 of the third preferred embodiment is that, in the capacitive touch panel 104, the insulating layer 170 covers the first connecting electrodes 150, and the insulating layer 170 has a plurality of contact holes 170 partially exposing the first connecting electrodes 150. In this embodiment, the contact holes 170H partially expose the first connecting electrodes 150 and the substrate 190, but the present invention is not limited to this. In other preferred embodiments of the present invention, the contact holes 170H may partially expose the connecting electrodes 150 only according to other considerations. Additionally, the insulating layer 170 of this embodiment may completely cover the substrate 190. In other preferred embodiments of the present invention, the insulating layer 170 may partially cover the substrate 190 according to other considerations. Each of the first sensing electrodes 130 is electrically connected to the first connecting electrode 150 through a contact hole 170H. Apart from the contact holes 170H in this embodiment, the other components, allocations and material properties of this embodiment are similar to those of the capacitive touch panel 103 in the third preferred embodiment detailed above and will not be redundantly described.

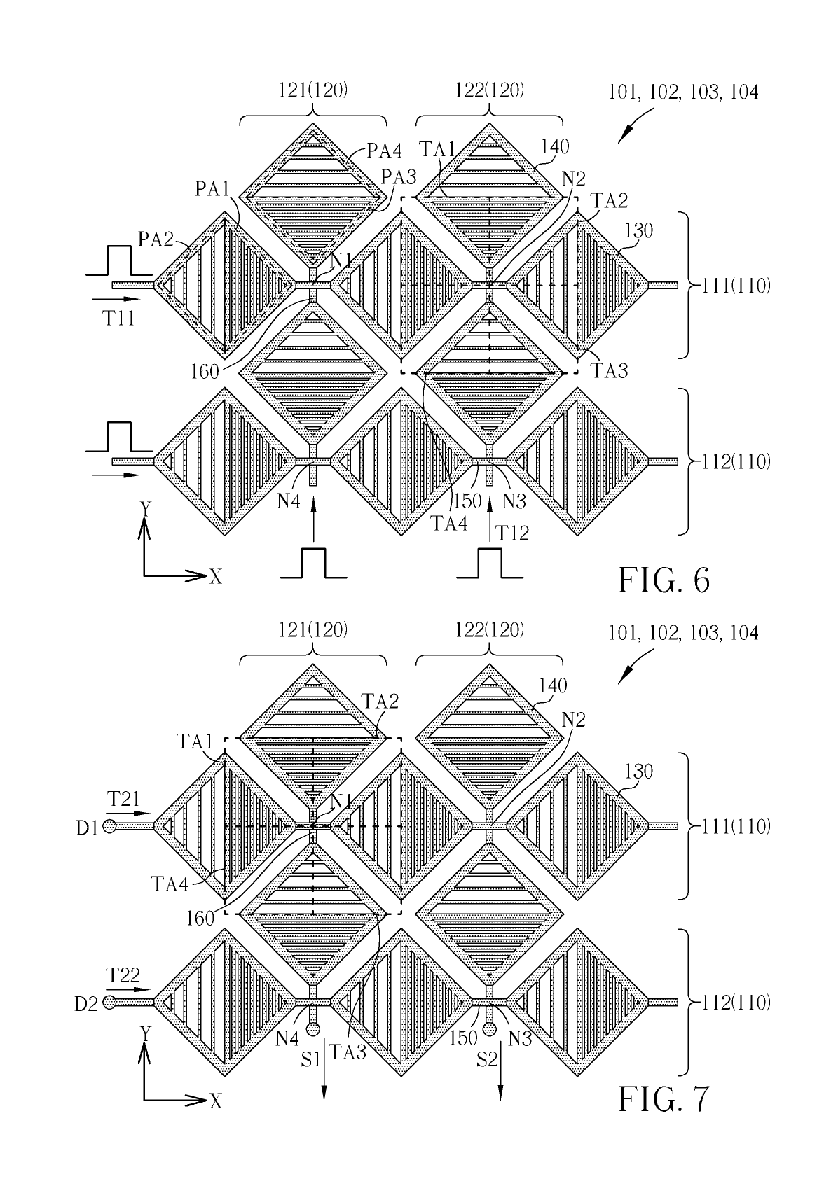

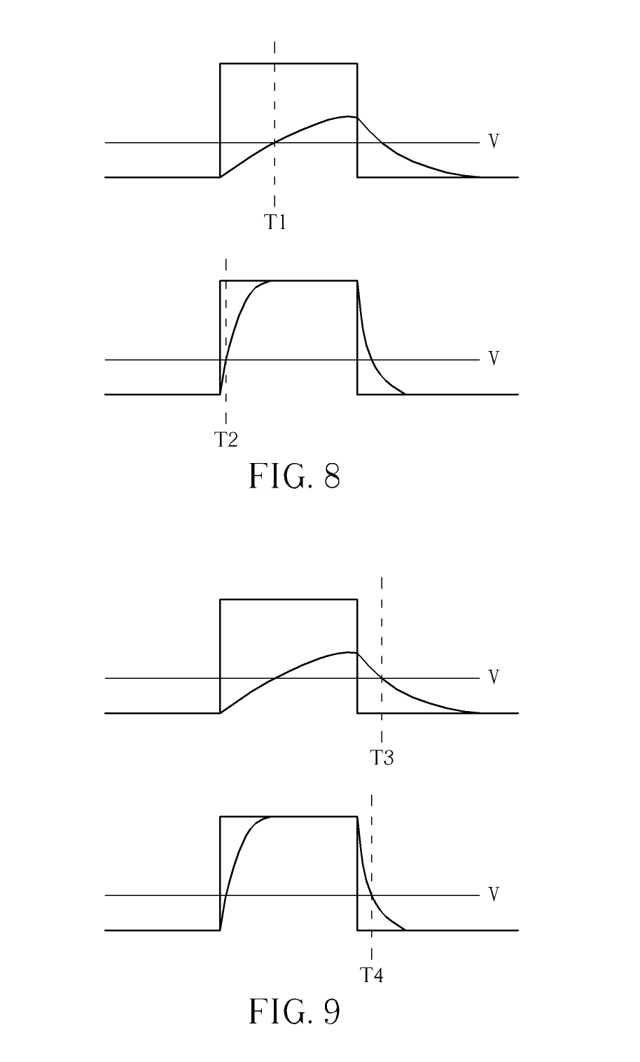

Please refer to FIG. 6, FIG. 8, and FIG. 9. FIG. 6, FIG. 8, and FIG. 9 are schematic diagrams illustrating a touch sensing operation of a capacitive touch panel under a first driving mode according to a preferred embodiment of the present invention. FIG. 8 is a schematic diagram illustrating a comparison of charging times in different regions with different pattern densities. FIG. 9 is a schematic diagram illustrating a comparison of discharging times in different regions with different pattern densities. As shown in FIG. 6, FIG. 8, and FIG. 9, under the first driving mode, the capacitive effects generated on the first electrode pattern region PA1, the second electrode pattern region PA2, the third electrode pattern region PA3, and the fourth electrode pattern region PA4 may be different from each other and can be differentiated from each other when a conductive touch object touches the first electrode pattern region PA1, the second electrode pattern region PA2, the third electrode pattern region PA3, or the fourth electrode pattern region PA4. For example, when the region with higher pattern density, such as the first electrode pattern region PA1 or the third electrode pattern region PA3, is touched, a time T1 used to charge up to a reference voltage V (as shown in the upper part of FIG. 8) may be longer than a time T2 used to charge up to the reference voltage V (as shown in the lower part of FIG. 8) when the region with lower pattern density, such as the second electrode pattern region PA2 or the fourth electrode pattern region PA4, is touched since the electrical capacitance formed on the region with higher pattern density is larger than the electrical capacitance formed on the region with lower pattern density. According to the same rule, when the region with higher pattern density, such as the first electrode pattern region PA1 or the third electrode pattern region PA3, is touched, a time T3 used to discharge down to the reference voltage V (as shown in the upper part of FIG. 9) may be longer than a time T4 used to discharge down to the reference voltage V (as shown in the lower part of FIG. 9) when the region with lower pattern density, such as the second electrode pattern region PA2 or the fourth electrode pattern region PA4, is touched. The differences between touching two adjacent regions with different pattern densities on one first sensing electrode 130 or on one second sensing electrode 140 may be discriminated according to the calculation of the charging times and the discharging times detailed above. Additionally, as shown in FIG. 6, the pattern density of the touch region TA2 is similar to the pattern density of the touch region TA4 because the touch region TA2 includes a part of the second electrode pattern region PA2 with lower pattern density and a part of the third electrode pattern region PA3 with higher pattern density, and the touch region TA4 includes a part of the first electrode pattern region PA1 with higher pattern density and a part of the fourth electrode pattern region PA4 with lower pattern density. Under the first driving mode, a sensing timing of the first axis electrode 110 may be differentiated from a sensing timing of the second axis electrode 120 so as to discriminate the differences between touching the touch region TA2 and the touch region TA4 and position the touch point. For example, a first axis electrode 111 may start sensing at a time point T11, a second axis electrode 122 may start sensing at a time point T12, which is different from the time point T11. Therefore, when the touch region TA2 is touched, the touch point will be positioned on the second electrode pattern region PA2 with lower pattern density at the time point T11 and be positioned on the third electrode pattern region PA3 with higher pattern density at the time point T12. Comparatively, when the touch region TA4 is touched, the touch point will be positioned on the first electrode pattern region PA1 with higher pattern density at the time point T11 and be positioned on the fourth electrode pattern region PA4 with lower pattern density at the time point T12. The differences between touching the touch region TA2 and the touch region TA4 may accordingly be discriminated. In this embodiment, the first driving mode may be regarded as a kind of self capacitance touch sensing driving mode. In other words, the capacitive touch panel in the present invention is suitable for a self capacitance touch sensing driving method.

Please refer to FIGS. 7-9. FIGS. 7-9 are schematic diagrams illustrating a touch sensing operation of a capacitive touch panel under a second driving mode according to a preferred embodiment of the present invention. As shown in FIGS. 7-9, under the second driving mode, sensing timings of the first axis electrodes 110 are separated from each other. More specifically, under the second driving mode, a driving signal may be delivered from a point D1 of a first axis electrode 111 at a time point T21, a signal Data1 may be accordingly received from a point S1 of a second axis electrode 121 at the time point T21, and another signal Data2 may be accordingly received from a point S2 of a second axis electrode 122 at the time point T21. Another driving signal may be delivered from a point D2 of a first axis electrode 112 at another time point T22, a signal Data3 may be accordingly received from the point S1 of the second axis electrode 121 at the time point T22, and another signal Data4 may be accordingly received from the point S2 of the second axis electrode 122 at the time point T22. A position may be calculated through an interpolation method utilizing the signal Data1, the signal Data2, the signal Data3, and the signal Data4 described above. In other words, when areas around a nod N1, a nod N2, a nod N3, and a Nod N4, which are formed by the first axis electrodes 110 and the second axis electrodes 120 crossing each other, are touched, the driving method described above may be employed to position the touch points. Additionally, in the present invention, the touch resolution may be enhanced by the first sensing electrodes and the second sensing electrodes having electrode pattern regions with different pattern densities around the nods. For instance, the capacitive effects generated on the touch region TA1, the touch region TA2, the touch region TA3, and the touch region TA4 around the nod N1 may be different from each other and may be employed to determine the touch point. In addition, the differences in the charging times and the discharging times described above may also be used in the second driving mode to determine the touched regions. The calculation of the charging times and the discharging times under the second driving mode is similar to the first driving mode detailed above and will not be redundantly described. It is worth noting that even if the pattern density of the touch region TA2 is similar to the pattern density of the touch region TA4, the differences between touching the touch region TA2 and the touch region TA4 around the nod N1 may still be discriminated under the second driving mode because the electrical properties around the nod N2 may also be influenced when the touch region TA4 around the nod N1 is touched. The signal Data2 received from the point S2 may accordingly become a little different, but the signal Data3 received from the point S1 and the signal Data4 received from the point S2 will not be influenced. The touch point will be positioned on the touch region TA2 instead of the touch region TA4 by cross referring the signals described above. A multiple touch points may also be positioned through the driving and calculating methods of the second driving mode. In this embodiment, the second driving mode may be regarded as a kind of mutual capacitance touch sensing driving modes. In other words, the capacitive touch panel in the present invention may also be suitable for mutual capacitance touch sensing driving method.

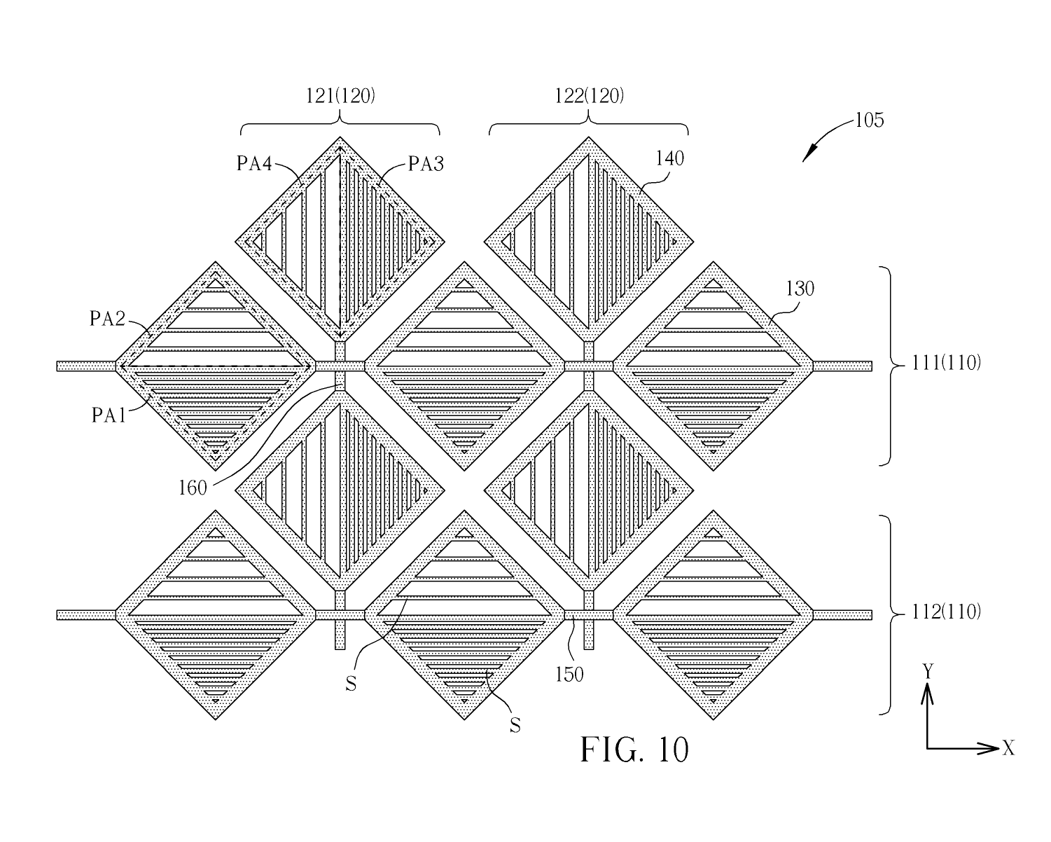

Please refer to FIG. 10. FIG. 10 is a schematic diagram illustrating a capacitive touch panel 105 according to a fifth preferred embodiment of the present invention. As shown in FIG. 10, the difference between the capacitive touch panel 105 of this embodiment and the capacitive touch panel 101 of the first preferred embodiment is that, in this embodiment, each of the first electrode pattern regions PA1 and each of the second electrode pattern regions PA2 are alternately disposed along the second direction Y, and each of the third electrode pattern regions PA3 and each of the fourth electrode pattern regions PA4 are alternately disposed along the first direction X. Apart from the allocations of the first electrode pattern region PA1, the second electrode pattern region PA2, the third electrode pattern region PA3, and the fourth electrode pattern region PA4 in this embodiment, the other properties, such as the material properties, the modification method of the pattern density in each electrode pattern region, and the calculation methods under the driving modes in this embodiment are similar to those of the preferred embodiments detailed above and will not be redundantly described. It is worth noting that in the previous embodiment, the pattern density of the electrode pattern region is modified by varying the spacing between the stripe patterns and maintaining fixed widths of the stripe patterns, but the present invention is not limited to this and the pattern density of the electrode pattern region may also be modified by controlling the area of the pattern and/or the spacing between the patterns.

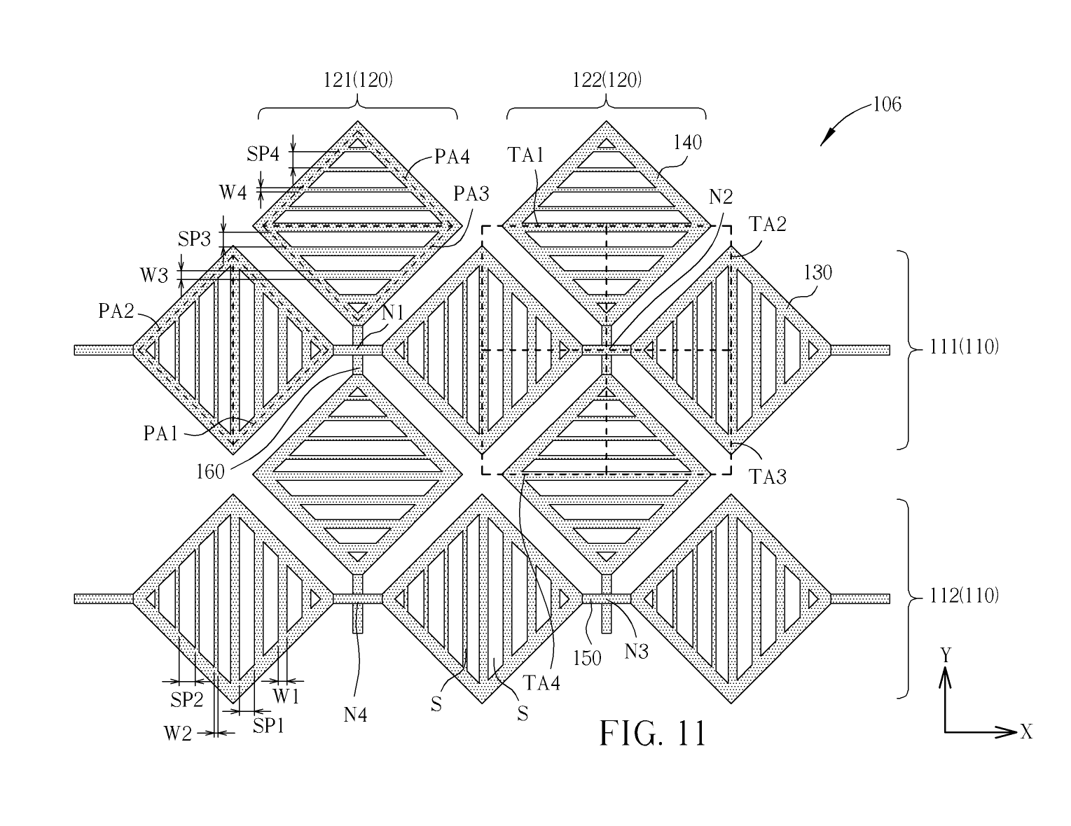

Please refer to FIG. 11. FIG. 11 is a schematic diagram illustrating a capacitive touch panel 106 according to a sixth preferred embodiment of the present invention. As shown in FIG. 11, the difference between the capacitive touch panel 106 of this embodiment and the capacitive touch panel 101 of the first preferred embodiment is that, in this embodiment, a spacing SP1 between two adjacent stripe patterns S in the first electrode pattern region PA1 may be equal to a spacing SP2 between two adjacent stripe patterns S in the second electrode pattern region PA2, and a width W1 of each of the stripe patterns S in the first electrode pattern region PA1 may be different from a width W2 of each of the stripe patterns S in the second electrode pattern region PA2. A spacing SP3 between two adjacent stripe patterns S in the third electrode pattern region PA3 may be equal to a spacing SP4 between two adjacent stripe patterns S in the fourth electrode pattern region PA4, and a width W3 of each of the stripe patterns S in the third electrode pattern region PA3 may be different from a width W4 of each of the stripe patterns S in the fourth electrode pattern region PA4. The pattern densities may be accordingly different in the electrode pattern regions.

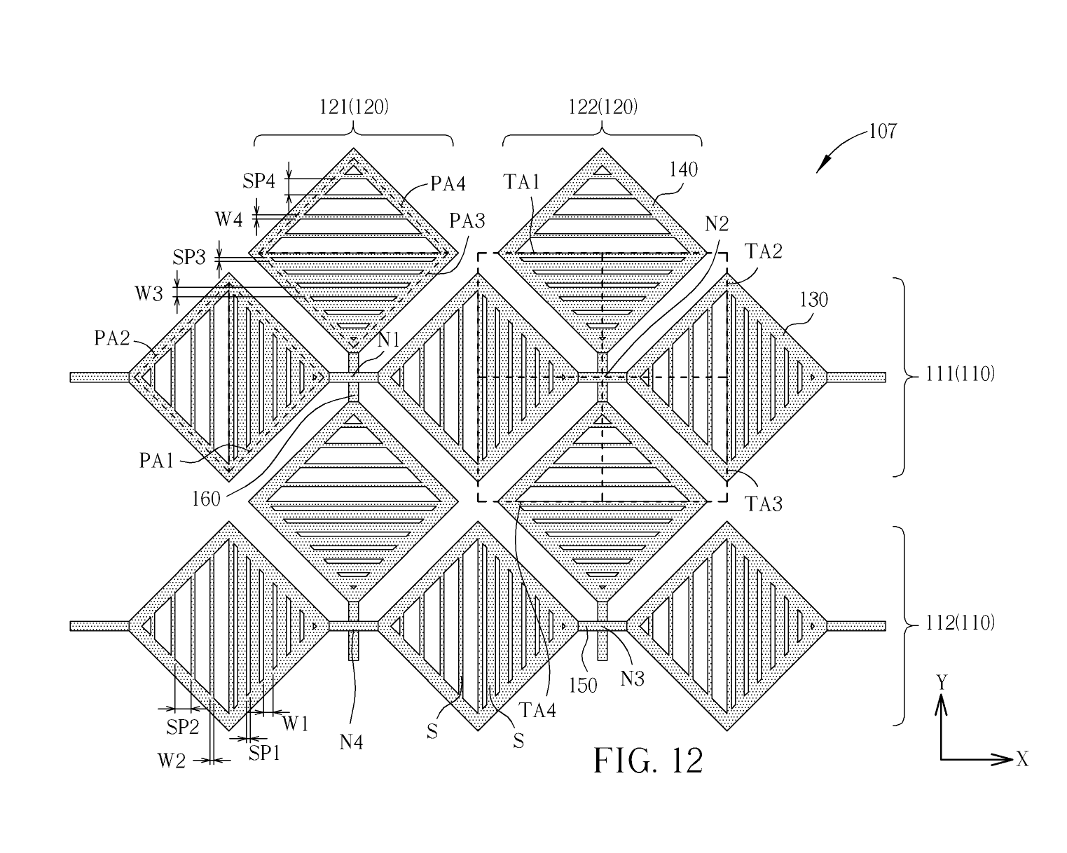

Please refer to FIG. 12. FIG. 12 is a schematic diagram illustrating a capacitive touch panel 107 according to a seventh preferred embodiment of the present invention. As shown in FIG. 12, the difference between the capacitive touch panel 107 of this embodiment and the capacitive touch panel 101 of the first preferred embodiment is that, in this embodiment, a width W1 of each of the stripe patterns S in the first electrode pattern region PA1 may be different from a width W2 of each of the stripe patterns S in the second electrode pattern region PA2, and a spacing SP1 between two adjacent stripe patterns S in the first electrode pattern region PA1 may be different from a spacing SP2 between two adjacent stripe patterns S in the second electrode pattern region PA2. A width W3 of each of the stripe patterns S in the third electrode pattern region PA3 may be different from a width W4 of each of the stripe patterns S in the fourth electrode pattern region PA4, and a spacing SP3 between two adjacent stripe patterns S in the third electrode pattern region PA3 may be different from the spacing SP4 between two adjacent stripe patterns S in the fourth electrode pattern region PA4. The pattern densities may be accordingly different in the electrode pattern regions.

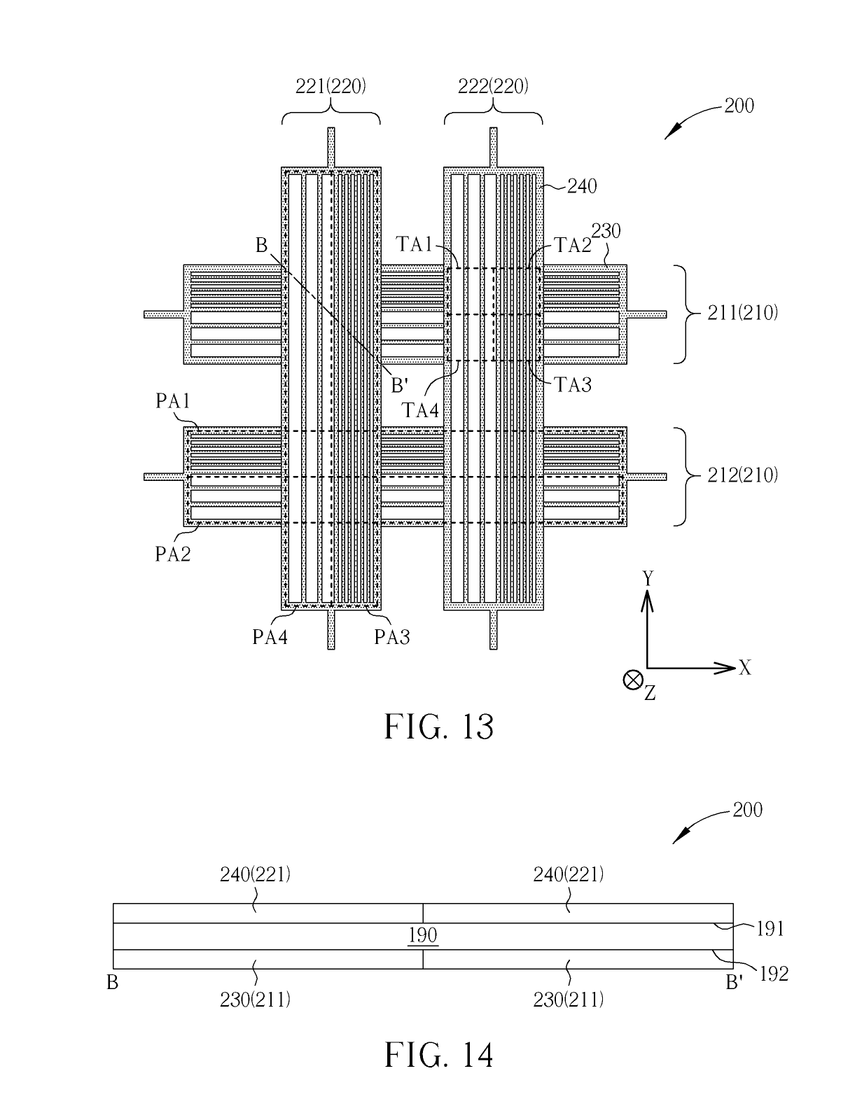

Please refer to FIG. 13 and FIG. 14. FIG. 13 and FIG. 14 are schematic diagrams illustrating a capacitive touch panel according to an eighth preferred embodiment of the present invention. FIG. 13 is a top-view diagram and FIG. 14 is a cross-sectional view diagram taken along cross-sectional line B-B′ in FIG. 13. As shown in FIG. 13 and FIG. 14, the eighth preferred embodiment of the present invention provides a capacitive touch panel 200. The capacitive touch panel 200 includes a substrate 190, a plurality of first axis electrodes 210, and a plurality of second axis electrodes 220. The first axis electrodes 210 are disposed on a second surface 192 of the substrate 190, and each of the first axis electrodes 210 extends along a first direction X. Each of the first axis electrodes 210 may include one first sensing electrode 230. The second axis electrodes 220 are disposed on a first surface 191 of the substrate 190, and each of the second axis electrodes 220 extends along a second direction Y. Each of the second axis electrodes 220 may include one second sensing electrode 240. In this embodiment, the first direction X is substantially perpendicular to the second direction Y, but not limited thereto. It is worth noting that each of the first sensing electrodes 230 may include a long stripe electrode extending along the first direction X, each of the second sensing electrodes 240 may include a long strip electrode extending along the second direction Y, and each of the first sensing electrodes 230 partially overlaps the second sensing electrodes 240 along a third direction Y perpendicular to the substrate 190. Variations of vertical capacitances formed in the regions where the first sensing electrodes 230 overlap the second sensing electrodes 240 may be employed to position the touch points on the capacitive touch panel 200. In this embodiment, each of the first sensing electrodes 230 has a first electrode pattern region PA1 and a second electrode pattern region PA2, and each of the second sensing electrodes 240 has a third electrode pattern region PA3 and a fourth electrode pattern region PA4. A pattern density of the first electrode pattern region PA1 is higher than a pattern density of the second electrode pattern region PA2, and a pattern density of the third electrode pattern region PA3 is higher than a pattern density of the fourth electrode pattern region PA4. It is worth noting that each of the first electrode pattern regions PA1 and each of the second electrode pattern regions PA2 are alternately disposed along the second direction Y, and each of the third electrode pattern regions PA3 and each of the fourth electrode pattern regions PA4 are alternately disposed along the first direction X. A touch region TA1, a touch region TA2, a touch region TA3, and a touch region TA4 may be formed in a region where each first axis electrode 210 crosses each second axis electrode 220. The touch resolution may be enhanced because the capacitive effects generated on the touch region TA1, the touch region TA2, the touch region TA3, and the touch region TA4 may be different from each other. Apart from the long strip electrodes and the allocation of the first axis electrodes and the second axis electrodes in the capacitive touch panel 200 of this embodiment, the other properties, such as the material properties, the modification method of the pattern density in each electrode pattern region, and the calculation methods under the driving modes in this embodiment are similar to those of the preferred embodiments detailed above and will not be redundantly described.

To summarize the above descriptions, in the capacitive touch panel of the present invention, different axis electrodes respectively includes sensing electrodes, and each of the sensing electrodes has electrode pattern regions with different pattern densities. The differences in the capacitive effects may be employed to enhance the touch resolution of the capacitive touch panel without changing the size of the sensing electrode. Additionally, the channel number in the processor of the capacitive touch panel of the present invention may be reduced comparatively to the traditional capacitive touch panel with identical touch resolution. The purposes of design simplification and cost reduction may accordingly be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch panel, comprising:
a substrate;
a plurality of first axis electrodes, disposed on the substrate, extending along a first direction, wherein each of the first axis electrodes comprises at least one first sensing electrode, and the first sensing electrode has a first electrode pattern region and a second electrode pattern region; and
a plurality of second axis electrodes, disposed on the substrate, extending along a second direction, wherein each of the second axis electrodes comprises at least one second sensing electrode, and the second sensing electrode has a third electrode pattern region and a fourth electrode pattern region,
wherein a pattern density of each of the first electrode pattern regions is higher than a pattern density of each of the second electrode pattern regions, and a pattern density of each of the third electrode pattern regions is higher than a pattern density of each of the fourth electrode pattern regions.

2. The capacitive touch panel of claim 1, wherein each of the first sensing electrodes and each of the second sensing electrodes comprise a plurality of stripe patterns.

3. The capacitive touch panel of claim 2, wherein a width of each of the stripe patterns in the first electrode pattern region is equal to a width of each of the stripe patterns in the second electrode pattern region, and a spacing between two adjacent stripe patterns in the first electrode pattern region is different from a spacing between two adjacent stripe patterns in the second electrode pattern region.

4. The capacitive touch panel of claim 2, wherein a width of each of the stripe patterns in the third electrode pattern region is equal to a width of each of the stripe patterns in the fourth electrode pattern region, and a spacing between two adjacent stripe patterns in the third electrode pattern region is different from a spacing between two adjacent stripe patterns in the fourth electrode pattern region.

5. The capacitive touch panel of claim 2, wherein a spacing between two adjacent stripe patterns in the first electrode pattern region is equal to a spacing between two adjacent stripe patterns in the second electrode pattern region, and a width of each of the stripe patterns in the first electrode pattern region is different from a width of each of the stripe patterns in the second electrode pattern region.

6. The capacitive touch panel of claim 2, wherein a spacing between two adjacent stripe patterns in the third electrode pattern region is equal to a spacing between two adjacent stripe patterns in the fourth electrode pattern region, and a width of each of the stripe patterns in the third electrode pattern region is different from a width of each of the stripe patterns in the fourth electrode pattern region.

7. The capacitive touch panel of claim 2, wherein a width of each of the stripe patterns in the first electrode pattern region is different from a width of each of the stripe patterns in the second electrode pattern region, and a spacing between two adjacent stripe patterns in the first electrode pattern region is different from a spacing between two adjacent stripe patterns in the second electrode pattern region.

8. The capacitive touch panel of claim 2, wherein a width of each of the stripe patterns in the third electrode pattern region is different from a width of each of the stripe patterns in the fourth electrode pattern region, and a spacing between two adjacent stripe patterns in the third electrode pattern region is different from a spacing between two adjacent stripe patterns in the fourth electrode pattern region.

9. The capacitive touch panel of claim 1, wherein a shape of the first electrode pattern region is symmetric to a shape of the second electrode pattern region of the first sensing electrode, and a shape of the third electrode pattern region is symmetric to a shape of the fourth electrode pattern region of the second sensing electrode.

10. The capacitive touch panel of claim 1, wherein each of the first axis electrodes comprises a plurality of first sensing electrodes disposed along the first direction and a plurality of first connecting electrodes respectively disposed between two adjacent first sensing electrodes to electrically connect the first sensing electrodes of one first axis electrode; each of the second axis electrodes comprises a plurality of second sensing electrodes disposed along the second direction and a plurality of second connecting electrodes respectively disposed between two adjacent second sensing electrodes to electrically connect the second sensing electrodes of one second axis electrode; and the capacitive touch panel further comprises an insulating layer disposed on the substrate, wherein the insulating layer at least partially disposed between the first connecting electrode and the second connecting electrode.

11. The capacitive touch panel of claim 10, wherein each of the first electrode pattern regions and each of the second electrode pattern regions are alternately disposed along the first direction, and each of the third electrode pattern regions and each of the fourth electrode pattern regions are alternately disposed along the second direction.

12. The capacitive touch panel of claim 10, wherein each of the first electrode pattern regions and each of the second electrode pattern regions are alternately disposed along the second direction, and each of the third electrode pattern regions and each of the fourth electrode pattern regions are alternately disposed along the first direction.

13. The capacitive touch panel of claim 1, wherein each of the first sensing electrodes includes a long stripe electrode extending along the first direction, each of the second sensing electrodes includes a long strip electrode extending along the second direction, and each of the first sensing electrodes partially overlaps the second sensing electrodes along a third direction perpendicular to the substrate.

14. The capacitive touch panel of claim 13, wherein the substrate has a first surface and a second surface, the first axis electrodes are disposed on the second surface of the substrate, and the second axis electrodes are disposed on the first surface of the substrate.

15. The capacitive touch panel of claim 13, wherein each of the first electrode pattern regions and each of the second electrode pattern regions are alternately disposed along the second direction, and each of the third electrode pattern regions and each of the fourth electrode pattern regions are alternately disposed along the first direction.

16. The capacitive touch panel of claim 1, wherein under a first driving mode, a sensing timing of the first axis electrode is separated from a sensing timing of the second axis electrode, a charging time and a discharging time of the first axis electrode when the first electrode pattern region is touched are longer than a charging time and a discharging time of the first axis electrode when the second electrode pattern region is touched, and a charging time and a discharging time of the second axis electrode when the third electrode pattern region is touched are longer than a charging time and a discharging time of the second axis electrode when the fourth electrode pattern region is touched.

17. The capacitive touch panel of claim 1, wherein under a second driving mode, sensing timings of the first axis electrodes are separated from each other, a charging time and a discharging time of the first axis electrode when the first electrode pattern region is touched are longer than a charging time and a discharging time of the first axis electrode when the second electrode pattern region is touched, and a charging time and a discharging time of the second axis electrode when the third electrode pattern region is touched are longer than a charging time and a discharging time of the second axis electrode when the fourth electrode pattern region is touched.
